(19) United States
(12) Patent Application Publication
(10) Pub. No.: US 2004/0013853 A1
(43) Pub. Date: Jan. 22, 2004

(54) Non-slip covering sheet for covering surfaces overlaid with fabrics

(76) Inventors: Jozsef Mandzsu, Radvany u. 19 (HU); Jozsef Mandzsu, Nyirfa u. 17 (HU); Zoltan Mandzsu, Bod Peter Lejto 4 (HU)

Correspondence Address: DUANE MORRIS LLP, 100 COLLEGE ROAD WEST, SUITE 100, PRINCETON, NJ, 08540-6604, US

(21) Appl. No.: 10/432,175

(22) PCT Filed: Nov. 20, 2001
(86) PCT No.: PCT/HU01/00119

(30) Foreign Application Priority Data
Nov. 21, 2000 (HU) P0004635

(51) Int. Cl. B32B 1/00

(52) U.S. Cl. 428/143; 428/906

(57) ABSTRACT

Non-slip covering sheet (1) for covering surfaces overlaid with fabric that on its lower surface (4) to be connected with the fabric overlying the surface to be covered, on the entire surface or on its one or more parts, has antislip protrusions (5) for the antislip engagement with the free fibres of the fabric overlying the surface to be covered, and its antislip protrusions (5) are constituted by suitably rigid and strong roughening particles (7, 5) fixed with a random orientation to its lower surface (4) and at least some of the antislip protrusions (5) are such that their height is between 40 microns and 3000 microns and their perpendicular projection to the lower surface (4) is bigger than their section with the lower surface (4). The non-slip covering sheet (1) is wound up in a reel (2) around a winding core (16) and/or has a size smaller than or equal to 20 square metres.

### TECHNICAL FIELD

The invention relates to non-slip covering sheet for covering surfaces overlaid with fabric, more particularly the invention, on the one hand, is related to domestic articles and particularly, for example, to protecting sheets for covering carpeted floors (e.g. home, hotel, fairground or other floors), to bed-covers for protecting the lying surface of the bed, to sanitary protecting covers for furniture and to table mats. The invention, on the other hand, is related to floor or ceiling covers to be generally used in vehicles, at vehicle passenger accommodation or to such other vehicle fittings that serve for covering the cargo compartment or luggage compartment of a vehicle. The invention is also related to methods and systems in connection with utilising the said products.

### BACKGROUND OF THE ART

Surfaces overlaid with cloth or fabric, such as indoor floor coverings, are often covered with several kinds of covering sheets against pollution (e.g. dust, mud), for example in case of constructing activities, bad weather or other, temporarily dirty, circumstances. The simplest such covering sheets are covering sheets made of polyethylene film or paper. These are rectangular covering sheets, made up properly folded (i.e. made compact doubled up on itself a number of times) or wound up into reels, whose sizes can be chosen from a wide choice, depending on the continuous size of the surfaces to be covered. For the sake of example, some common sizes (in metres×metres): polyethylene film covering sheets made up folded: 5×4, 2×12, 4×25, 2×6, 3×4, polyethylene film covering sheets made up wound up into reels: 2×50, 2×25, 2×12, 4×25, 4×50, paper covering sheets made up wound up into reels: 1×30, 1×20, 2×20. For smaller surfaces to cover, all of these are made up in smaller sizes, for example in case of entrance-hall floormats or vehicle floormats these sizes can be much smaller, e.g. below 1 m².

A known drawback of such covering sheets is that they easily slip up on the covered surface. Many solutions are known to solve this problem, in some of which the edge of the covering sheet is fixed with adhesion tapes all around after laying down, while in others the covering sheet has, at its lower surface, antislip means. The solutions mentioned also differ in the kinds of the antislip means. According to U.S. Pat. No. 5,962,350 the antislip means is a pressure sensitive adhesive layer. According to U.S. Pat. No. 5,816,305 fabric-upholstered furniture can be covered with a sanitary covering sheet having a self adhesive bottom. According to U.S. Pat. No. 4,822,669. and U.S. Pat. No. 5,130,187 the antislip means is a foam of a sticky character (e.g. polyurethane or EP-PE butylene closed cell foam). In other solutions the antislip means is comprised of soft, elastic stick-enhancing bumps. Thus, for example, in U.S. Pat. No. 5,567,497 there are slightly projecting plastic ribs whose substance is sufficiently resilient to prevent slipping. Also, in U.S. Pat. No. 5,173,346 the antislip means is constituted by tiny dots printed onto the lower surface-whose elastomeric material forms a rubber-like, sticky surface, while in U.S. Pat. No. 4,917,932 the lower surface is covered with a thick layer made up of a mixture of rubber crumbs and PVC which gives a resilient, rough lower surface of a high-scale unevenness to the covering sheet. In U.S. Pat. No. 5,227,214 the antislip means is constituted by regularly arranged protrusions of a regular shape, moulded from the rubber-like substance of the lower surface. In a further group of the known solutions, the antislip means in constituted by that the lower surface of the covering sheet comprises an inelastic, non-planar relief. Thus, for example, in U.S. Pat. No. 5,149,572 the lower surface is corrugated cardboard whose ribs form antislip elements, while in U.S. Pat. No. 5,733,629 the lower surface is a polymer layer that is non-smooth due to having been moulded onto an embossed or micro-roughened mould. It is still another type of solutions in which discrete, regularly arranged, hard, dot-like (i.e. not line-like) protrusions, humps form an antislip means. An example for that is U.S. Pat. No. 4,941,551 in which low and flat, button-like, hard protrusions serve simultaneously as breathing-spacer and antislip means. In other solutions the lower surface has, as antislip means, protrusions expressly penetrating between the fibres of the cloth or fabric overlying the covered surface. Thus in U.S. Pat. No. 5,667,873 the lower surface is a mat-roughened surface that comprises regularly arranged, uniform, truncated-cone-shaped engaging protrusions projecting perpendicularly from the surface and formed from the substance of the surface, and in U.S. Pat. No. 5,15,2572 regularly arranged, small, blunt protrusions, e.g. blunt hooks or points, are used against the planar slipping that can be stuck into the fabric. In still another kind of solutions strong bristles (e.g. wild boar bristles) project from the lower surface and the bristles stick with the fabric. This solution is revealed in U.S. Pat. No. 4,361,610. and U.S. Pat. No. 4,377,610. Finally, a solution can be using male components of hook-and-loop fasteners (i.e. resilient stems having hooks and regularly projecting from the surface) fixed to the lower surface that can, in the hook-and-loop way, either be fixed with the female component of the hook-and-loop fastener fixed to the floor or even with the covered cloth surface itself. The male component of the hook-and-loop fastener is fixed to the lower surface in the form of certain strips. Such solutions are described in U.S. Pat. No. 4,968,548., U.S. Pat. No. 4,609,580. and U.S. Pat. No. 5,083,831.

All of the aforementioned solutions are unsatisfactory for covering surfaces overlaid with fabric in some respects. If only the edges or other smaller surface portions of the covering sheet are fixed then the whole surface of the flexible covering sheet slips, wrinkles and is drawn on the surface overlaid with fabric. The self adhesive lower surface can practically only be used in case only certain small portions of the lower surface are covered with pressure sensitive adhesive but this results in the slipping up of the surface parts left free. Pressure sensitive adhesive can not be used well in wet or dusty circumstances, and it can not be detached and replaced repeatedly and it pollutes and is also too expensive. The foam of sticky character, covering the lower surface, indeed performs a certain antislip effect but this effect (especially in wet or dusty circumstances) is insufficient and, in addition, this kind of a product is too thick, too heavy and too expensive. The same is the case with the soft, resilient stick-enhancing bumps. The antislip effect of the antislip means constituted by an inelastic, non-planar relief is also insufficient, especially in wet or dusty circumstances. This is also true for antislip means constituted by discretely arranged, hard, dot-like (i.e. not line-like) protrusions or humps. The antislip means comprising regularly arranged and shaped, e.g. moulded, protrusions penetrating the fibres of the covered fabric surface provides, in the most cases, a considerable non-skid effect but only at those points of the covering sheet that are supplied with such protrusions and these protrusions must just be being pressed into the surface of the fabric. The same is the case with the bristle solutions, too. Such penetrating elements, which do not have hooking shapes, in case they are not being pressed against the fabric, can be pulled out of the fabric and slipped up on it with a lateral force. In addition, their manufacturing is very expensive and covering the whole surface of the covering sheet with them is particularly expensive. The hook-and-loop male components, i.e. the stems having hooks, are very expensive therefore only few little, special portions of the lower side of the covering sheet can be economically covered with them. This has the drawback that the hook-and-loop component is, even in this small quantity, too expensive and, in addition, the surface parts of the covering sheet left free are free to slip up and the hook-and-loop fastener, which indeed provides an excellent strength against slipping, is very hard to detach and therefore the covering sheet must also be designed to be too strong and too expensive. Also, male hook-and-loop components are too thick.

There is an especially strong need for such a covering sheet with which even the non-horizontal surfaces overlaid with fabric, e.g. fabric upholstery, can be covered, typically in the passenger foot area or luggage compartment of vehicles where the fabric upholstery, to be covered, bows up around the horizontal surfaces. There are not any known cheap solutions in which up to the whole of the surface of the covering sheet sticks, in a detachable way still strongly enough, to even the vertical surfaces overlaid with fabric, e.g. fabric upholstery, in the said spots of the vehicles. These places can, in addition, typically be dusty and/or wet when laid over.

### DISCLOSURE OF THE INVENTION

The main object of the invention is providing a non-slip covering sheet for covering surfaces overlaid with fabric, whose antislip means can, even in dusty or wet circumstances, be very effective, cheap, thin, lightweight, flexible, multiply and easily detachable and covering a surface portion relatively big in relation to the covering sheet (preferably covering the whole of the surface). Further it is an object that the covering sheet should be able to be laid over the surface overlaid with fabric easily and smoothly. It is also the object to present further advantageous solutions at the field of the invention.

The following considerations have lead to the development of the invention. From PCT publication WO 98/34775, in the technical field of thermoplastic packaging materials, a solution is known according to which the slipping up on each other of two thermoplastic packaging films is prevented by forming a system from the films to be fixed, at least one of which is roughened,, and an engaging element in a way that such a roughened film is applied that has surface protrusions of a proper closeness, an engaging element of a loose fibrous structure having inherent strength, e.g. thin non-woven fabric, is placed on the film or on its certain parts, on the whole surface of on surface parts, the engaging element comprising the elementary filaments in such closeness and layer thickness that a mechanical grip is formed between the elementary filaments of the engaging element and the protrusions of the roughened film. The surface protrusions are preferably polymer granules welded to the surface and the section between the particles and the plane of the film preferably does not cover the shape of projection of the particles viewed perpendicularly to the film and the binding element is preferably fixed to one of the films. This known solution does not contain any teaching (objectives, recognition or solutions) regarding non-slip covering sheets for covering surfaces overlaid with fabric since its technical field is utterly different.

According to the recognition of the present invention our main object can be achieved by properly transforming the said published solution to our present technical field. As an analogy to the, therein mentioned, binding element, in our present case, the fabric overlying the surface to be covered can be utilised. In the lower surface of the non-slip covering sheet antislip protrusions can be formed for the antislip engaging with the free fibres of the fabric. The solution can really well utilised for such fabric surfaces in which, close to the surface of the fabric, the direction of the free fibres or threads of fibres also contains a component parallel with the surface. Such are, for example, the looped or non-woven carpets or car upholstery but, for example, carpets having cut fibres, such as the usually more expensive plush carpets, are different. The widest range of application of the sanitary covering sheets is, on the one hand, as a household means, related to covering the floor carpets of the fairgrounds during the building up of the booths, temporarily covering the floor carpets of offices, business rooms, hotel or airport corridors or other high-traffic places and, on the other hand, to covering the foot mats and luggage compartments upholstered with fabric in vehicles. In all of these applications the fabric overlying the surfaces to be covered is, almost without exception, looped or non-woven.

After having studied the commonly used fabric surfaces, e.g. carpets, upholstery, to be covered we have come to a result that in order of our main object the particles forming the antislip protrusions must be sufficiently rigid and strong in order that they can, during the penetration, spread for themselves the free fibres and that they can sustain with them an engagement of a strength appropriate for the aim of application. In accordance with the fibre size and fibre looseness of the commonly used (new or used i.e. pressed down) fabrics or upholstery such protrusions are necessary that are neither too big nor too small. It has been found that the necessary height is between 40 microns and 3000 microns. In order of a shear-direction engagement strength, sustainable even in lack of a direct normal-direction pressure, it is necessary that the protrusions form certain undercuts which means that the perpendicular projection of the protrusion to the surface carrying it is bigger than its section with the surface.

Thus the new product is essentially a non-slip covering sheet for covering surfaces overlaid with fabric that on its lower surface to be connected with the fabric, on the entire surface or on its one or more parts, has antislip protrusions for the antislip engagement with the free fibres of the fabric overlying the surface to be covered, which is new inasmuch as its antislip protrusions are constituted by suitably rigid and strong roughening particles fixed with a random orientation to its lower surface and at least some of the antislip protrusions are such that their height is between 40 microns and 3000 microns and their perpendicular projection to the lower surface is bigger than their section with the lower surface.

As it was said, in the case of the known covering sheets the way they are made up (e.g. multiple folding or winding up into a reel) and their size are basically determined by the size of the surface overlaid with fabric to be covered. Thus also in case of the new covering sheets, as a hidden possibility, it is possible to make up the product in all the different sizes and methods, folded and wound up, as usual. However, surprisingly and just because of the great surface and very high fixing strength of its novel antislip means, some of the possible ways making up the product provide an applicability better by a qualitative leap than that provided by the rest of the ways. Namely the thing is that while the ordinary covering sheets can be laid down (e.g. by multiple folding out) onto a big surface, overlaid by fabric, more or less wrinkled and slanting and then the wrinkles can be removed by edges of the covering sheet being pulled out and the slanting covering sheet can be turned into the proper orientation by turning, this pulling out and smoothing will not be possible in the case of the new covering sheet because every point of the roughened surface of the covering sheet engages stubbornly, e.g. like thistles, with the fabric surface in connection with them. Therefore the lying of the new covering sheet can only be corrected by the whole or at least a bigger part of the covering sheet being utterly lifted off the fabric overlying the surface to be covered and being repositioned again in a proper position. According to our observations, due to this respect, those ones of the theoretically possible ways of making up the product in which the covering sheet is made up wound up in a reel around a winding core (i.e. not multiply folded and flat) or its size does not exceed 20 square metres are more advantageous by a qualitative leap than the others. Reels, kept rigid by the winding core, can easily be properly laid down for the first attempt straight and wrinkle-free and the lying of the covering sheet of a not too big surface can yet be corrected the above mentioned way. Surfaces overlaid with fabric, bigger than 20 m², can thus be covered either with a covering sheet wound up in a reel or with several smaller rectangular ones. This character makes the new covering sheet especially fit and advantageous for such applications in which relatively smaller surfaces overlaid with fabric are to be covered. Such are covering the entrance-hall carpet or the foot carpet or luggage compartment of a vehicle.

According to this, the essence of the invention is a non-slip covering sheet for covering surfaces overlaid with fabric that on its lower surface to be connected with the fabric, on the entire surface or on its one or more parts, has antislip protrusions for the antislip engagement with the free fibres of the fabric overlying the surface to be covered, which is new inasmuch as its antislip protrusions are constituted by suitably rigid and strong roughening particles fixed with a random orientation to its lower surface and at least some of the antislip protrusions are such that their height is between 40 microns and 3000 microns and their perpendicular projection to the lower surface is bigger than their section with the lower surface, the non-slip covering sheet being wound up in a reel around a winding core and/or having a size smaller than or equal to 20 square metres.

By covering sheet a thin or thick, disposable or multiple use, flexible or rigid, single layered or multiple layered product is meant possibly being homogeneous or composite in its substance, whose most common utilisation is protecting from pollution the surface overlaid with fabric, e.g. upholstery, carpet etc., but in addition to this it can have further functions, too, such as providing a non-slip engagement with the surface overlaid with fabric for different purposes or decoration in which latter case the upper surface of the covering sheet can have a decorative ornamentation, pattern or image. In the case of the fabric overlying the surface to be covered the word fabric means woven, knitted, non-woven (e.g. fleece or felt), flocked, velour or plush type fabric or any other kind of fabric, cloth-upholstery, linen, carpet etc. as the non-slip covering sheet can be advantageously utilised with all of these. Preferably the whole of the lower surface is roughened in order of a better antislip effect. As it is known the orientational state of the particle is the direction of the-spatial co-ordinate system ordered to the particle in relation to the co-ordinate system of the said lower surface. The particles are fixed to the lower surface with random orientation which means that the particles can be in any of their possible orientation states so none of their such orientation states are either excluded or required. Thus there is no such state defined in which the particle could be abnormally upside down and the particle has no special points that should look, for example, upward or downward. This provides two advantages. On the one hand it makes the product very cheaply manufactured since the bringing of particles onto a surface in the random orientation way, e.g. sprinkling, is a method easier, simpler and cheaper than any other different method. Taking an illustrative example, it is simpler and easier to throw down the same dice randomly than putting them down in such a manner that the upper surface of all the dice show e.g. an even number or the number six. The regularly shaped and regularly arranged protrusions of the known earlier solutions could not be made this way. It is a further significant cost-decreasing factor that in our case simply-shaped, cheap particles, e.g. granules, can be used which are obviously cheaper than, for example, stems having hooks or regular truncated cones. On the other hand, the random character is isotropic i.e. it provides an antislip effect of about the same extent in all directions. The particles are preferably solid i.e. not hollow, not foamed. The particles can be granules whose material can be plastic or other materials e.g. saw dust. When the product is being made, the protrusions might possibly be even better fixed to the surface by an additional pressing or rolling operation which possibly modifies the final shape of the protrusions more or less flattening their tops. This operation can actually be useful and essentially does not increase the costs. Thus the present invention also regards such covering sheets whose antislip protrusions are constituted by rigid and strong roughening particles, preferably sprinkled granules, fixed with a random orientation to its lower surface, the protrusions having, in their entirety or just around their tops, more or less flattened shapes. Thus a new, distinguishing property of the invented product is that a certain random, stochastic character or irregularity is effective in the arrangement and/or shape of its protrusions (i.e. in the shape and/or orientation state of the particle forming the protrusion) which distinguishes it from products moulded in moulds or made up in other utterly regular ways.

The roughening particles are suitably rigid and strong which means that, unlike, for example, the protrusions foamed lightweight or the elastic, soft, flexible protrusions such as soft rubberised humps, they do not deform, do not break but rather behave as rigid bodies when pressed between the fibres of the fabric and when exposed to a shear load common with covering sheets. A certain extent of deformation can, of course, occur which does not affect the utilisation as long as it can assure the penetration between the fibres and the sufficiently strong hooking with the fibres. As for hardness and rigidity, the dimensioning of the particles can be more accurately done knowing the particular, aimed application. For the most practical utilisation purposes it is well suitable if the roughening particles are powder granules consisting of a solid plastic or polymer. The fixation of the particles must be strong enough to be able to transfer the necessary load to the covering sheet. The fixation can be e.g. welding and/or adhesion. The adhesion can be such in which the particle and the surface fix with the help of a further additional adhesive material or can be such in which the necessary adhesion is provided by the substance of the particle and/or the surface without further adhesive materials, for example if the particle is a so called hot melt polymer adhesive granule such as ethylene-acrylic esther-maleic anhydride terpolymer adhesive granule. The additional adhesive material can be a crosslinking adhesive, for example an adhesive or lacquer crosslinking by UV light, which can cover the surface between the protrusions in its entirety or in parts only, e.g. only around and next to the protrusions. The height of at least a part of the antislip protrusions is between 40 microns and 3000 microns where the height is the greatest extent in normal direction of the protrusion related to the said lower surface. The perpendicular projection of the said protrusions to the lower surface is bigger than their section with the lower surface and this ensures that the shape of the protrusion is such that it overhangs to the side, over its own fixation surface, to at least a certain extent and thus forms an undercut or undercuts in which the free fibres of the fabric overlying the surface to be covered can get caught. The protrusions are expedient to be dimensioned, for the particular applications, knowing the properties of the fabric, e.g. carpet or upholstery, to be covered, in a way that the distance between them, their height and width, the distance between the lower surface and their widest part etc. should make it the easiest possible for the protrusions to penetrate the deepest possible between the free fibres or threads of fibres and for the free fibres or bundles of fibres to hook on the protrusions, preferably on their lower, narrower parts.

The product can be made up wound up in a reel around a winding core independent of its size which, in a topological sense, means that the covering sheet is wound up around a winding axis in several turns with the usual winding regularity and thus it forms a cylinder-like reel having an approximately circular outer cross section. The main topological character of the reel is that its cross section is a curve of spiral topology. Within this, the reel can be a single layer reel or a multi-layer reel which refers to the single-layer or multi-layer character of the spiral curve in its cross section. The reel is wound up around the winding core which gives rigidity to the reel. The substance of the winding core is usually paper but it can be a different suitable material, too. The reel may possibly be flattened (e.g. due to storage) but this flattening can be pressed back and thus the reel can be made more regular in order of easier unwinding. It is advantageous in order of easier layability if the outer surface of the reel is the roughened lower surface of the covering sheet. The covering sheet being not bigger than 20 m² can also be made up multiply folded or in other, non-wound forms. There can be also tearing perforations in the made up product in order to help tearing off smaller portions. The covering sheets, corresponding to the given concrete applications, can of course also have non-rectangular shapes e.g. arched.

The advantage of the invented covering sheet is that it is very suitable for covering surfaces overlaid with fabric because its antislip means is, even in dusty or wet circumstances, very effective, cheap, thin, lightweight, flexible, can be easily and repeatedly detached and can cover a surface portion relatively big in relation to the covering sheet (preferably the whole of the surface of the covering sheet). In addition, the covering sheet can be laid over the surface to be covered overlaid with fabric easily and smoothly. As a sanitary covering sheet it is advantageous for example because one can form a rim, projecting from the surface of the covered fabric in a free, loop-like manner along the edges of the covering sheet, by lifting the edge of the covering sheet and by moving it inwards and laying it down again, beyond which rim the edge of the covering sheet is also fixed down to the fabric lying over the covered surface. This heightened rim prevents pollution from getting off the covering sheet. The product can uniformly be used with new or already stamped fabrics, carpets, upholstery however in the case of some heavily used, felted fabrics it can be advantageous to loosen up the fibres of the fabric before its utilisation, for example with a brush or in other ways.

In the respect of the main objective it is advantageous if the covering sheet is able to engage, with the highest possible strength, with fabrics of the most possible kinds of quality and fibre structure. According to our observations in this respect it is advantageous if the greatest size of at least a part of the antislip protrusions according to the invention is between 150 microns and 1000 microns.

It is even more advantageous in the same respect if the greatest size of at least a part of the antislip protrusions according to the invention is between 200 microns and 700 microns.

Also in the respect of engagement with surfaces to be covered overlaid with fabrics of the most possible kinds of quality and fibre structure it is advantageous if the covering sheet simultaneously has antislip protrusions of different sizes. This means that it is advantageous if the quotient of the heights of the highest and lowest antislip protrusions of the covering sheet is at least 1.1. In the same respect it is even more advantageous if the quotient of the heights of the highest and lowest antislip protrusions of the covering sheet is at least 1.5.

It is advantageous if the covering sheet sticks not only on a surface overlaid with fabric, e.g. on a carpet, but also on a hard floor. This can be achieved with such a non-slip covering sheet which also has such antislip protrusions that are comprised of such particles, preferably granules, that are commonly suitable to stick with a hard surface, due to their surface substance being somewhat sticky. For this purpose, as a substance-component, any of the commonly used agents can be utilised such as suitable rubber, rubber-derivative, elastomer, plastomer, linear low density polyethylene (LLDPE), ethylene-vinyl-acetate (EVA), poly-isobuthylene (PIB) etc. It is advantageous if the height of these protrusions is at least partly greater than that of the said, suitably hard and rigid antislip protrusions according to the invention because thus they are to touch the floor if the covering sheet is laid over a hard, smooth floor and thus they provide sticking. It is advantageous if these protrusions, made of a substance also sticking to hard floors, are at the same time sufficiently hard and rigid to act as antislip protrusions providing an engagement with the fibres of the fabric. Such protrusions can be made, for example, of certain polyethylene granules containing EVA.

In the respect of the break-off strength of the antislip protrusions it is advantageous if at least a part of the antislip protrusions of the lower surface, preferably a high proportion of theirs (more preferably at least 60% of them, or at least 75% of them or, even more preferably, at least 95% of them), is such that the quotient of the area of the section of the protrusion with the plane of the lower surface and the area of the perpendicular projection of the protrusion to the plane of the lower surface is high, concretely the said quotient is at least 0.05, preferably at least 0.15, more preferably at least 0.30, even more preferably at least 0.50.

In the respect of effective hooking between the antislip protrusions and the fibres of the fabric overlying the surface to be covered it is advantageous if at least a part of the antislip protrusions of the lower surface, preferably a high proportion of theirs (more preferably at least 60% of them, or at least 75% of them or, even more preferably, at least 95% of them), is such that the quotient of the area of the section of the protrusion with the plane of the lower surface and the area of the perpendicular projection of the protrusion to the plane of the lower surface is low, concretely the said quotient is at most 0.95, preferably at most 0.85, more preferably at most 0.70, even more preferably at most 0.50.

The strength and rigidity of the protrusion is in connection with its body density which is the quotient of its mass and its volume. In the respect of the main object it is advantageous if the body density of at least a part of the antislip protrusions is greater than 500 kg/m³, preferably greater than 800 kg/m³.

In the respect of the main object it is advantageous if the covering sheet contains a water-impermeable plastic layer. In the respect of costs it is advantageous if the lower surface is a water-impermeable plastic layer (e.g. polyethylene) to which polymer granules, preferably of polyethylene, are fixed, preferably with welding. This is, for example, such an inexpensive embodiment which makes the product disposable.

The antislip protrusions form a fixing in the shear-direction with the fibres of the fabric overlying the surface to be covered. This results in such a load to the protrusion which endeavours to turn it with a torque and thus to free the hooked fibre. In certain cases this can lead to the lower surface bending from its original plane around the protrusion and thus making it possible for the protrusion to turn away. In order of preventing this, it is advantageous if the covering sheet has a certain rigidity. This can be ensured, for example, by the covering sheet comprising such a plastic layer whose mass is at least 10 grams per square metre. The layer constituting the lower surface is preferably a plastic layer having a mass of at least 10 grams per square metre, even more preferably of at least 20 grams per square metre. For the sake of comparison : the typical mass of the ordinary polyethylene film covering sheets is less than 6.7 grams per square metre which already provides them with the strength that they need. Also in the respect of increasing the rigidity, it is advantageous if the covering sheet, preferably in its lower surface, comprises a layer of high density polyethylene whose mass is at least 940 kg/m³. The layer constituting the lower surface and the potential further layers above it can be bonded with each other at certain surface parts, the surface parts being essentially uniformly distributed, e.g. in a matrix of dots. These bonding surface parts can cover 1% or 2% or even up to 100% of the total surface. In case the lower layers, e.g. plastic film and paper layers, are bonded, e.g. adhered or welded, to each other in at least 5% of their surface then they resist the said bending load in an approximately unitary way. Thus it is advantageous if the common mass of the lower layers of the covering sheet fixed to each other in pairs in surface parts being essentially uniformly distributed and making up at least 5% of their surface is at least 10 grams per square metre. It is clear that the problem of the fibres escaping from the hooking can very well be solved by making the lower layer(s) thicker and more rigid but this, in any given case, must be kept in accordance with costs permitted at the given application, e.g. disposable product.

The higher lifting and peeling strength of the fixing with the fabric overlying the surface to be covered can be achieved by forming protrusions of special shapes. In a disadvantageous case the surface of the antislip protrusion is smooth, e.g. shiny, but it is more advantageous if the surface of at least a part of the antislip protrusions is concave, more preferably the antislip protrusion has a concave outline which means that it has such a view in which its outline looks concave. The concave i.e. recessed surface parts of such particles having irregular, randomly non-uniform orientation make such an engagement with the free fibre sections of the fabric surface possible that has a required lifting and peeling strength, all due to the fibres entering the concave recesses of the particle. Also in the same respect it is advantageous if the covering sheet has in its lower surface such hooking protrusions that contain such a hooking particle (preferably: granule) that is, directly or indirectly, fixed to some protrusion projecting from the said lower surface. This can be simply prepared by, for example, fixing granules to the lower surface and then getting and fixing to them further granules preferably not perpendicularly to the surface but slanted, e.g. at a 45° angle. The advantage of such protrusions is that they form such recesses or undercuts which increase the lifting and peeling strength and, at the same time, they are still cheap enough to produce.

The said proprietary feature of the new covering sheet, i.e. the strong dependence of its ability to be laid flat and smooth on its size, makes the covering sheet especially advantageous at applications of smaller surfaces. Thus in this respect it is advantageous if the size of the covering sheet is smaller than 10 m², preferably smaller than 5 m², 2 m², even more preferably smaller than 1 m².

Due to the said dependence on size, it is especially advantageous if the covering sheet is serving for covering the passenger area (e.g. foot-area) and/or luggage compartment of a vehicle (e.g. car, bus, aeroplane) i.e. a covering sheet formed for this purpose, for example having a shape corresponding to this purpose and/or being identified in its packaging as a covering sheet for this purpose. These are, namely, applications of a small surface. In addition, here it is very significant that the new covering sheet, in a unique way, moulds and adapts well to and also fixes well, in its whole surface, with the surface parts or rims of the covered surface overlaid with fabric and bending up, being vertical or even facing downwards, up to horizontally, and thus a complete tub-like covering can be formed of the covering sheet. Thus the tub shaped foot area or luggage compartment of the car can excellently be covered with it in which case the covering sheet can even be adhered to the side walls slanting backwards, of the luggage compartment and with a sufficient strength Its proper lifting and peeling strength make it possible to correct a false placing by lifting off and replacing while prevent the covering sheet from dropping by itself from the slanting or downward-facing upholstered surfaces. An upholstery already wet and/or dusty can also be well covered with it. These advantageous properties of the product can be utilised with a unique efficiency in the application in vehicles. Thus this covering sheet can be applied in the field of applying in vehicles better by a qualitative leap than in other fields such as in the field of applying in households while other, known covering sheets do not offer such unexpected and special advantages in the field of applying as antislip coverings in vehicles over the fields of other applications.

In the case of application in vehicles the shape of the covering sheet can be different from rectangle, e.g. it can be arched or it can have a shape that fits best to the special geometry of the vehicle, e.g. to the shape of the wheel drum. Due to the close room offered in a vehicle, the easy layability can preferably be ensured by the covering sheet being made up in a single wound i.e. single layer reel in a way that the outer surface of the reel is the said roughened lower surface. Thus it is enough to simply unroll the covering sheet. In the typical using circumstances the user lines the luggage compartment of the car with the disposable covering sheet when he just wants to put something into the luggage compartment that is already muddy, wet or dusty. At this time the luggage compartment already contains other things, e.g. commonly stored there, which would not be practicable to be fully removed for the sake of the lining. Therefore it is advantageous if the width of the covering sheet for the luggage compartment of a car is less than the width of the luggage compartment. This results in one only having to line one portion of the luggage compartment at a time while one can move the things being there to the other portion. The two covering sheets preferably overlap each other and the overlapping will not slip apart because the covering sheets do not slip. Thus it is, in a practical respect, advantageous if at least one width of the covering sheet for lining the luggage compartment of a car is smaller than 120 cm, more preferably smaller than or equal to 80 cm. In the floor in front of the driver's seat in the car there is typically a smooth e.g. plastic, un-upholstered patch that is to be the place of the heel of the driver. This is typically surrounded by upholstered surface. The new covering sheet fixes stronger to the floor if its size, especially in the lengthwise direction, is big enough for the covering sheet to fully span over the smooth surface portion and to engage with the fabric portions over its edges at both sides. Thus in a practical respect it is advantageous if at least one width of the covering sheet for covering the floor in front of the driver's seat of a car is greater than 30 cm, more preferably at least 50 cm.

There is often also a removable floor mat on the floor in front of the seats of the car. If this floor mat is upholstered then it is practicable to simply cover the floor mat and the surrounding floor carpet with the non-slip covering sheet. In any case, but especially if the said floor mat is un-upholstered, e.g. rubber mat, it can be advantageous to fold down the non-slip covering sheet, placed above the floor mat, under the edge of the floor mat along the front and/or rear edge of the floor mat. With this, the antislip protrusions are pressed against the lower, usually sticky, surface of the floor mat and the covering sheet stays in place even if there is a strong slipping, lateral load.

It often happens that by the time the new car is taken over by its first owner the inner headliner upholstery gets dirty. The pollution can be caused by the error of the factory workers or forwarders. The inner headliner of a new or used car displayed for sale can be polluted by the numerous inquirers. The inner headliner upholstery of the car also gets polluted during normal use, e.g. due to vapour precipitation, or smoking. Cleaning the inner headliner is difficult. It is our object to provide a, preferably disposable, covering sheet easily fixable to the inner headliner upholstery facing downwards and easily removable therefrom. According to our recognition our object can be achieved through the fact that the antislip protrusions of the covering sheet laid over the upholstered inner headliner create with the fibres of the upholstery an antislip engagement of appropriate lifting and peeling strength which makes it possible to correct a false positioning by lifting off and replacing the covering sheet but prevents the covering sheet from accidentally falling off the upholstery surface facing downwards. Thus the covering sheet according to the present invention is preferably such that it is formed as a covering sheet for covering the fabric-upholstered inner headliner of the passenger and/or cargo compartment. The covering sheet according to the invention is preferably such that it is formed as a covering sheet for covering the downward-facing, slanting or essentially horizontal, fabric-upholstered surfaces of the passenger and/or cargo compartment having antislip protrusions for creating with the free fibres of the upholstery an engagement of appropriate lifting and peeling strength. The covering sheet according to the invention is preferably such that it is formed, by means of its suitable shape and its antislip protrusions serving for an engagement of suitable lifting and peeling strength with the free fibres of the fabric-upholstery to be covered, as a covering sheet for covering the inner headliner fabric upholstery of the passenger and/or cargo compartment.

It is especially advantageous if the said covering sheet has decorative pictures, image or text in its upper surface opposite to its antislip protrusions since this can be used for making an extraordinary decoration in the inner headliner of the car. The image can comprise a commercial advertisement which can be frequently changed together with the covering sheet. This can be advantageous in a taxi, for example.

Ordinary covering sheets, especially polyethylene films, are often made up in a gussetted form. Within that, they can either be in reels with cores or multiply folded. It is a typical way of making up the product, for example, in which the tube, laid flat, of the polyethylene film is gussetted, from the two sides, right to the central line and then either of the outer surfaces is slit lengthwise in the middle. The ordinary covering sheet made up this way can be laid down in a way in which it is laid down the floor with its un-slit surface facing down and then it is grabbed at the two edges of the slit facing upwards and the film portions are extended in opposite directions while also the side-gussets are, slipped along the floor, unfolded. This method is popular because this way the width of the reeled-up or folded package is only a fraction, e.g. one-fourth, of the fully spread or extended width of the film. This method, however, can surprisingly not be properly applied with the new covering sheet. The background of this fact is, also, that the covering sheet can not be swept or slipped along the fabric overlying the surface to be covered thus the gusset, having a roughened inner surface, must be spread out in the air which is not practicable and which can practically only be carried out in the case of covering sheets not bigger than 5 m². Thus, in the respect of easy and smooth spreadability, it is advantageous if the size of the covering sheet is smaller than or equal to 5 m² and/or the covering sheet is free of gussets made from the roughened side. (Inside such a gusset two roughened surfaces lie upon each other.) It is advantageous if the covering sheet is made up in a way of folding and/or winding that does not require the slipping of its lower surface over the covered surface during the spreading out. One of these ways is, for example, the case in which the lengthwise centre-folded covering sheet, thus forming a half tube of roughened outer surface, is wound up or is furled up without a core. In addition to the said lengthwise centre-fold, further folds can be, in any direction, in the covering sheet as long as they do not form such gussets which would have to be spread out with moving the roughened surface along the floor. The advantage of such a covering sheet is that it can gradually be unfurled or unrolled onto the covered surface placing at once the proper portions of the covering sheet to their final destinations on the carpet and there is no need for spreading out the gussets in the air or with pulling them on the fabric overlying the covered surface.

The new non-slip covering sheet, being for example, in one of its most practicable forms, a polyethylene film having a bottom roughened with antislip protrusions and a smooth top, proposes a new problem. The plastic surfaced covering sheets used earlier were rather poorly fixed, against slipping, to the carpet or upholstery below them thus the slipperiness of their upper surface was not critical as the covering sheet slipped up on the fabric overlying the covered surface usually earlier than the object touching the covering sheet from above, e.g. a shoe sole, slipped up on the covering sheet. The new covering sheet, however, does not slip up on the fabric overlying the covered surface thus the slipperiness of its plastic upper surface prevents the fill utilisation of all the antislip possibilities. For example, if the floor carpet of the fairground is covered, for the period of time of erecting the booths, with the covering sheet, such a covering is created that does not slip up on the floor carpet but still, people walking over it can not move confidently enough on the smooth, slippery upper surface. In the respect of our related object, i.e. the increasing of the antislip character, it is advantageous if the upper surface, opposite the lower surface for the connection with the fabric overlying the surface to be covered, of the covering sheet has on its entire surface or on part or parts of its surface, as antislip means, roughening, foamed layer and/or elastic layer and/or rubber-like e.g. elastomeric layer and/or a material of a filamentous and/or fibrous structure. The covering sheet is possibly a polyethylene film whose both surfaces are uniformly roughened with antislip protrusions. Thus it is not necessary to take care about the distinguishing of the sides during the covering. Providing a foamed, elastic, rubber-like, e.g. elastomeric layer in the outer surface of the covering sheet a very efficient antislip device can be formed that can, for example, be applied spread over the upholstered luggage compartment of a vehicle. This way the covering sheet safely engages with the upholstery and the suitcase or other piece of luggage put on it can adhere to the surface layer to such an extent that practically not even the strongest braking can shift the luggage which is important in the respect of comfort as well as of safety. At the same time, the potential, slight lifting force applied to the covering sheet, during the removal of the suitcase, due to the stick of the upper surface layer to the suitcase is withstood by the lifting force provided by the undercut roughening and this prevents the covering sheet from being accidentally taken out together with the suitcase or from getting crumpled. If it was not for the lower antislip means the covering sheet would slip up together with the suitcase and would, on its being taken out, be accidentally taken out and get crumpled. Applying a material of filamentous and/or fibrous structure is advantageous cost-wise, e.g. in the form of a layer of paper or cheap fabric such as thin non-woven fabric especially in the case of disposable covering sheets i.e. those used for a short period of time. In addition, the non-slip covering sheet can also be used in order that, fixed to the bottom of certain objects such as a toolkit or a first aid box or a container, it prevents the said objects, typically always stored in the luggage compartment of the car, from slipping up in the luggage compartment. In addition to the luggage compartment, of course, other upholstered surfaces of the car can also be advantageously covered with the covering sheet such as shelves, cargo plates, hat shelves, glove recesses etc.

As it was seen the making of the upper surface of the covering sheet non-slippery is of high importance. At the sanitary applications the contamination may not only contain dry dirt but also some moisture e.g. water and wet mud. Apart from the covering sheets made especially for absorbing which can take up as much water as up to several litres per square metre, the presence of moisture, e.g. a dropped spot of paint or mud taken in as in the case of polyethylene floor covering films, is commonly tolerated as long as the moisture in not so much as to pour off the covering sheet and contaminate the protected carpet. In the case of the new covering sheet, however, the enhanced slipperiness caused by the small quantity of surface moisture prevents the antislip possibilities from being fully exploited. Our related object is to provide such a form of the invented covering sheet that eliminates the slipperiness caused by moisture getting to its upper surface, being opposite to its lower surface for contacting the fabric overlying the surface to cover, by absorbing the moisture e.g. by thus drying out the wet spots of mud smeared upon it. In this respect the covering sheet is advantageously such that it has an absorbent means at least partially absorbing the moisture getting to its upper surface. This absorbent means can be an absorbent layer positioned over the whole surface or just surface parts which can be the upper surface layer or can, as well, be under the upper surface layer in which case it is necessary that the upper surface layer is permeable to moisture. In a possible case, for example, the upper layer of the covering sheet is a perforated polyethylene film below which the absorbent layer is located, for example a thin layer of cellulose collected in spots, which practically makes the upper surface non-slip. A more serious absorbent capacity can be achieved by applying absorbent, means like a suitable quantity of cellulose, paper, absorbent synthetic cloth or absorbent, hydrocolloid polymers e.g. the so-called SuperAbsorbent Polymer (S.A.P.). Such a forming of the upper (and also lower and side) surface is preferable that is impermeable for the material constituting the absorbent means. In this respect such a covering sheet is advantageous whose upper surface layer is paper or more preferably non-woven polymer fabric of sufficient fibre closeness or even more preferably paper covered from outside with non-woven synthetic fabric which can thus even retain the gel-state SuperAbsorbent Polymer. As absorbent paper preferably unsized paper is used as it has a greater absorbency. It is preferable to dimension the said retaining layers such that they can normally take up the absorbent material of an increased volume and can withstand its potential increased pressure. For this purpose, in one or more layers, spacer elements e.g. polystyrene beads can be used by which a free space can be sustained for the absorbent material between the impermeable layers. In the respect of strength it is advantageous to apply load transmitting bridges that are solid even when wet and that lead through the layers that get pulped when wet which can be, for example, a non-water-soluble adhesive totally soaking the paper layer or a lack of continuity in the layer not solid when wet, for example a round hole through which the neighbouring solid e.g. plastic layers are directly fixed to each other. With this solution such a covering sheet can be provided that stays solidly in one even if the whole of its surface gets soaked with moisture. It is in general preferable to ensure a high shear strength for the fixation between the layers considering the non-slip character of the product. It is preferable if the breaking strength of the lowest water impermeable layer against the rubbing load coming from above is higher than that of the layers above it because this way in case of utilisation resulting in a too strong load the damage in the product can already be noticed (and properly reacted to) when the water impermeable layer is not yet damaged.

A non-slip covering sheet, manufactured very inexpensively and thus disposable and having an absorbent upper surface of reduced slip, can be formed in a way that its water impermeable layer constituting its lower surface is a continuous plastic (preferably polyethylene) layer that carries the antislip protrusions that are plastic preferably polyethylene) granules fixed (preferably welded) to the plastic layer and its other layer is the paper layer constituting the absorbent upper surface of reduced slip onto which the plastic layer is fixed in the whole of its surface, the kind of the fixation preferably being coating with hot, molten polymer. The chemical composition of the polyethylene, for example, is in this case such which ensures in its hot state the solid fixation with paper as it is usual with polyethylenes used for coating paper.

Sometimes covering sheets are laid beside each other with a certain overlap and this way a bigger area is covered. At the overlap, the lower surface of the covering sheet lies on the upper surface of another similar covering sheet. The edges at the overlaps are usually, in lack of any better solutions, adhered down with tapes in order that the overlapped portions of covering sheets do not slip up on-each other. As it was seen, in the case of the new covering sheets the smaller sizes are typical thus an even greater need arises for applying overlaps. Our related object is providing a covering sheet whose upper surface, opposite to the covered surface, creates an engagement of reduced slipperiness with the bottom antislip protrusions of another similar covering sheet, this way making it possible to effectively cover a bigger surface overlaid with fabric with several covering sheets partially overlapping each other. The upper surface can be of the above mentioned quality only around the edges but it is an even more advantageous object that the whole upper surface should be of that quality since this could make it possible that neighbouring covering sheets can be overlapped with each other in any possible relative position.

This object is achieved with such a covering sheet whose upper surface, in the whole of its surface or in one or more surface parts, has roughened paper and/or resilient foamed material and/or non-woven fabric as a surface covering. In this sense roughened paper is any paper embossed and/or treated in other ways whose upper surface has such surface recesses and/or projections whose width, in top view, is at least 40 microns and crepe paper. By paper is meant any such product of fibrous structure, based on e.g. cellulose or wood, potentially treated chemically and with additives that is commonly called paper or cardboard. The antislip protrusions can sink and stick into these surface materials and they do not slip or hardly slip on them. This solution has the advantage that the bottom antislip protrusions of the covering sheet being on top at the overlap create an engagement of reduced slip with the roughened paper, elastic foamed material or non-woven cloth and these materials for upper side covering can be cheaply and simply applied for the whole surface of the upper side of the covering sheet. Thus there is no need for any additional means for fixing the edges to each other.

The same object can also be achieved with such a non-slip covering sheet whose upper surface, in the whole of its surface or in one or more surface parts, has, as a surface covering, a material of a loose fibrous structure that has free fibres and/or bundles of fibres that have free sections fixed at both ends to the upper surface, in which the thickness of at least a part of the free fibres and/or bundles of fibres is as small as possible, concretely smaller than the half, more preferably quarter, of the height of at least a part of the antislip protrusions and in which the material of fibrous structure is thick to such an extent and the looseness of its fibrous structure is of such an extent which makes it possible for at least a part of the antislip protrusions to enter the fibrous structure by means of at least a part of the antislip protrusions finding room in the free space between the free fibres and/or bundles of fibres of the material of fibrous structure. In this sense those are the free fibres or bundles of fibres that have such free sections which sections are free for the engagement in the sense that they are not closely surrounded by other fibres and which free sections are fixed to the upper surface at both of their ends. The said fixing can be direct or indirect, thus it can be such, for example, in which the ends of the fibre section are fixed to the other fibres of the material of fibrous structure forming the covering and are fixed to the upper surface below the material of fibrous structure indirectly i.e. with the multiple mediation of the other fibres of the material of fibrous structure. The free fibres are sufficiently thin in order that they can get hooked with the protrusions, preferably with the lower, narrower parts of the protrusions. The sufficiently great thickness and sufficient looseness of the material of fibrous structure, together, make it possible that the antislip protrusion that enters the fibrous structure finds sufficient room in the free space (or in the space opening free due to the penetration) among the free fibres and/or bundles of fibres of the fibrous structure, the room being enough for it in width as well as in depth by which the free fibres can hook onto the lower, narrower part of the protrusion. The said material of loose fibrous structure is preferably a non-woven polymer fleece.

This solution has the advantage that the bottom antislip protrusions of the covering sheet being on top at the overlap create an engagement with the material of loose fibrous structure which engagement is of a very decreased slip and, in case of necessity, even of sufficient lifting and peeling strength, and this surface covering of the upper surface, e.g. non-woven plastic fabric, can be cheaply and practicably utilised for the whole of the upper surface. Thus there is no need for any additional means for fixing the edges to each other.

At the place of the overlap the bottom antislip protrusions of the covering sheet being on top can essentially immerse into the material forming the upper surface of the covering sheet being below. In this case the free edge of the upper covering sheet constitutes such a step whose thickness is preferable to be kept low in order that there is a low probability of its unintentional bending up due to an accidental sticking or kicking. In this respect it is advantageous if the thickness, without the lower antislip protrusions, of the covering sheet is at most 2 mm, preferably 1 mm, more preferably 500 microns, even more preferably 200 microns. In the case of such a thin covering sheet there is only a very slight risk of an unintentional sticking with the free edge.

As it was seen, the covering sheet can comprise plastic components and other, e.g. paper, components, too. In an ecological respect it is advantageous if all of the plastic components can be recycled together, preferably the same kind of polymer. In the same respect, it is advantageous if the components dissimilar in the respect of recyclability i.e. those that can not be recycled together (e.g. the plastic and the individual non-plastic components) are formed in separate layers of inherent strength which layers have such fixing between each other whose tearing strength is lower than the tearing strength of the individual layers. This results in the components together non-recyclable being, as separate layers, able to be tom off each other and collected separately in order of recycling. In this sense the tearing strength of the layer if that force which causes during the separation a rip utterly crossing the layer in a direction perpendicular to the layer. Thus it is permissible that certain surface but not full-thickness pieces of the paper layer can, at the spots of adhesion, be torn off the paper layer. The fixation between the dissimilar layers can, for example, be an adhesion of proper strength, applied in regular spots.

It is known that the bed covering facing- or patient-underpad, typically sanitary and typically disposable, often slips off, gets wrinkled and crumpled under the lying person which is uncomfortable and does not any longer provide cleanness for the bed or mattress. According to our recognition an object of bed covering facing or patient-underpad of reduced slip can be achieved by means of the fact that the antislip protrusions of a covering sheet spread over the lying surface under the lying person overlaid with bed sheet form an antislip engagement with the fibres of the bed sheet. Thus the covering sheet according to the invention is preferably such that it is formed as a bed covering facing or patient-underpad comprising antislip protrusions for the antislip engagement with the fibres of the fabric or bed sheet overlying the lying surface to be covered. The bed covering facing or patient-underpad preferably also comprises water impermeable and absorbent layers.

Pets, e.g. dogs and cats, like to settle on pieces of upholstered furniture, e.g. coaches, beds, armchairs. On the other hand, these animals are often carried on passenger seats of cars, too. In both cases the pieces of furniture or the car seats, respectively, get in an undesired manner get contaminated with moisture and animal hair. This can be fought against with frequent cleaning or washing of the covers of the furniture or seats. It would be more comfortable to use disposable covers for furniture or seats but these could not be cheaply produced due to the complicated circumstances of geometry and fixation. And a simple planar covering sheet e.g. paper sheet can not be utilised because it immediately slips off the furniture or seat. According to our recognition, the object of a disposable furniture- or seat cover suitable for preserving the cleanness of upholstered furniture and vehicle seats can be achieved by means of the fact that the antislip protrusions of a covering sheet spread over the lying or sitting surface upholstered with fabric form an antislip engagement with the fibres of the upholstery. Thus the covering sheet according to the invention is preferably such that it is formed as a furniture- or seat cover comprising antislip protrusions for the antislip engagement with the fibres of the fabric upholstery of the sitting or lying surface to be covered. The furniture- or seat cover preferably also comprises water impermeable and absorbent layers and is preferably disposable. The antislip affect is not optimal in the case of plush upholstery to be covered but it is, due to the protrusions being pressed between the fibres of the plush, stronger than in the case of ordinary covering sheets of smooth lower surfaces. The seat cover for cars can also be well utlised at repairing activities and does not slip up under the mechanic.

There is a wide-spread utilisation of table covering sheets, placed on the dining table over the table-cloth, as placemats, bottle mats, glass underlays, table-runners or table-centres. These can slip up on the table-cloth for example when bread is being sliced on them or when a small child is dining who pulls off the placemat together with the dishes on it which, in case of a hot meal, can even be dangerous. For these purposes covering sheets of a suitable size, usually made of thick PVC film, are used whose bottom is laminated with cloth for increasing the stick. This does not provide sufficient adhesion and is too expensive, too. According to our recognition, the object of a table covering sheet, e.g. placemat, of decreased slip can be achieved by means of the fact that the antislip protrusions of a covering sheet spread over the dining table overlaid with a table-cloth of fabric form an antislip engagement with the fibres of the table-cloth. Thus the invented covering sheet is preferably such that it is formed as a table covering sheet or table placemat comprising antislip protrusions for the antislip engagement with the fibres of the table-cloth overlying the table to be covered. The table covering sheet or placemat preferably also comprises water impermeable and absorbent layers.

It is our object to introduce a system comprising a surface overlaid with fabric and a non-slip covering sheet covering it, the antislip means of the non-slip covering sheet being very effective even in dusty or wet circumstances and being inexpensive, thin, lightweight, flexible, multiply and easily detachable and of a great (preferably full) size in comparison to the covering sheet. It is our aim that the covering sheet can be easily and smoothly spread over the surface overlaid with fabric. The system achieving this object is essentially a system that comprises a covered surface overlaid with fabric and a non-slip protecting covering sheet covering the covered surface which non-slip protecting covering sheet has in its lower surface facing the covered surface antislip protrusions forming an antislip engagement with the free fibres of the fabric overlying the covered surface, the system being new in that as non-slip protecting covering sheet it comprises the non-slip covering sheet according to the invention, detailed in the above parts of the specification. The advantages of the system are essentially the same as those discussed earlier.

During the preparation of the floor of the fairgrounds the carpet is unrolled from a reel and the floor is covered with the carpet During this, the adhesion side of the carpet is adhered down to the raw floor and thus the walking side, overlaid with fabric, of the carpet gets to face upwards. According to what has been said so far, it is advantageous to cover the floor thus prepared overlaid with the carpet with the invented non-slip protecting sheet. This, however, is a relatively tiresome job and the carpet can get contaminated in the meantime. It is our object to provide such a solution with which it is easier to provide a floor overlaid with carpet covered with a non-slip covering sheet. According to our recognition, if the non-slip covering sheet is, during the previous rewinding of the carpet, properly wound into the carpet, between the turns of the reel of the carpet, with its lower surface having antislip protrusions facing the walking side surface of the carpet then by properly unrolling the thus produced product in one step the desired goal can be achieved. Thus the invented system is preferably such that it comprises a carpet, having a walking surface overlaid with fabric on its one side and an adhesion surface on its other side, and as a covered surface overlaid with fabric it comprises the walking surface overlaid with fabric of the carpet and it comprises, at least partly, the multilayer material composed of the carpet and the non-slip covering sheet covering its walking surface and being contiguous and in a non-slip engagement with its walking surface in the form of a reel. The advantage of this system is that it is comfortable to use. Its further advantage is that, due to its reeled form, it can also be of a large size.

It is preferable if the length, measured in the reeling forwarding direction, of the non-slip covering sheet and that of the carpet are, within the turns of the said reel, within the multilayer material, essentially the same. By means of this it can be achieved that the said layers can smoothly lie upon each other after the unrolling. Since the layers of identical length are, due to their thickness, positioned at different radii in the reel the said layers are being compressed and/or stretched in the reel. In order that the non-slip covering sheet is not stretched, it is advantageous if the non-slip covering sheet is placed at the side facing the centre of the reel of the said multilayer material and the carpet belonging to it is positioned toward the outer side of the reel from it. This means that the lower surface of the non-slip covering sheet having the antislip protrusions is that surface of the non-slip covering sheet that faces towards the outer side of the reel. This arrangement has the further advantage that the adhesion surface of the carpet faces toward the outer side of the reel by means of which the carpet can be laid with a simple unrolling. These advantages well compensate for the drawback that the reel, unlike the reels commonly sold, does not let the pattern of the walking surface of the carpet be seen.

It is also our object to provide new methods related to the revealed products and systems. The process according to the invention in its most general form is essentially a method for covering surfaces overlaid with fabric in which the surface overlaid with fabric is covered with as non-slip covering sheet in a way that the lower surface, provided with antislip protrusions, of the non-slip covering sheet is connected with the surface overlaid with fabric, the method being new in that as non-slip covering sheet the non-slip covering sheet according to the invention, discussed in the previous parts of the specification is applied.

As it was seen it is advantageous to cover fabric-upholstered parts of vehicles with the covering sheet according to the invention. Our related method is essentially a method for covering surfaces overlaid with fabric of passenger and/or luggage or cargo compartments of vehicles in which the surface overlaid with fabric is covered with a non-slip covering sheet in a way that the lower surface, provided with antislip protrusions, of the non-slip covering sheet is connected with the surface overlaid with fabric, the method being new in that as non-slip covering sheet the non-slip covering sheet according to the previous parts of the invention is applied. This method can, for example, be utilised in car factories, repair shops or second hand car retail shops and it can be used for the covering of the horizontal surfaces of the vehicle or, for example, for that of those that are vertical or that face horizontally downwards or for that of the seats.

Fabric-upholstered parts for vehicles are preferably covered already before they are mounted into the vehicle because this way the covering sheet can already protect the fabric-upholstered part during its shipment to the place of assembly and during the assembly. Our related method is essentially a method for covering surfaces overlaid with fabric of parts to be mounted into passenger and/or luggage or cargo compartments of vehicles in which the surface overlaid with fabric is covered with a non-slip covering sheet in a way that the lower surface, provided with antislip protrusions, of the non-slip covering sheet is connected with the surface overlaid with fabric, the method being new in that as non-slip covering sheet the non-slip covering sheet according to the invention described in previous parts of the specification is applied. This method can, for example, be utilised in factories producing car seats, floor inlays or inner headliners and it can be used for the covering of the upholstered panels or the vehicle seats. The covering sheet is preferably made to fit the size and shape of the covered surface.

As it was seen it is advantageous to cover carpeted household floor coverings with the invented covering sheet. Our related method is essentially a method for covering household floors overlaid with fabric, e.g. carpets, for protection in which the surface overlaid with fabric is covered with a non-slip covering sheet in a way that the lower surface, provided with antislip protrusions, of the non-slip covering sheet is connected with the surface overlaid with fabric, the method being new in that as non-slip covering sheet the non-slip covering sheet according to the invention detailed in previous parts of the specification is applied. This method is especially advantageous with covering carpet surfaces of fairgrounds.

As it was seen, it is even more advantageous to overlay the fairground area with such a carpet that is, already before the overlaying, supplied with a protecting covering sheet. Our related method is essentially a method for overlaying floors with carpet in which a reel containing carpet is provided, the material forming the reel is unrolled and the carpet is spread and smoothed over the floor surface with its adhesion surface facing towards the floor and with its walking surface facing upwards, the method being new in that as a reel containing carpet the invented system, comprising a reel formed by a multilayer material, is provided.

The method for the production of the said composite reel is essentially a method for producing a reel of carpet provided with covering sheet in which before the rewinding or during the rewinding the walking surface of the carpet is covered with a non-slip covering sheet and thereby a reel, formed of a multilayer material consisting of the carpet and the non-slip covering sheet covering its walling surface and being contiguous and in an antislip engagement with its walking surface, is created, the method being new in that as a non-slip covering sheet the non-slip covering sheet according to the invention discussed in previous parts of the specification is applied. According to a preferable method the multilayer material is formed of a carpet and a non-slip covering sheet of essentially the same length. It is a preferable method in which the non-slip covering sheet is positioned in the reel in a way that its lower surface having antislip protrusions is made to be its surface facing towards the outer side of the reel.

As it was seen it is advantageous to cover the bed sheet of the bed of bed-ridden patients or small children with the invented covering sheet, for example for sanitary purposes. Our related method is essentially a method for covering lying surfaces overlaid with fabric or bed sheet in which the lying surface overlaid with fabric or bed sheet is covered with a non-slip covering sheet in a way that the lower surface, provided with antislip protrusions, of the non-slip covering sheet is connected with the surface over-laid with fabric or bed sheet, the method being new in that as non-slip covering sheet the non-slip covering sheet according to the invention described in previous parts of the specification is applied. This method can be applied e.g. in hospitals.

As it was seen it is advantageous to cover the fabric-upholstered sitting or lying surfaces of pieces of furniture or seats with the covering sheet according to the invention, for example for sanitary purposes. Our related method is essentially a method for covering fabric-upholstered sitting or lying surfaces of pieces of furniture or seats in which the fabric-upholstered sitting or lying surface is covered with a non-slip covering sheet in a way that the lower surface, provided with antislip protrusions, of the non-slip covering sheet is connected with the fabric-upholstered surface, the method being new in that as non-slip covering sheet the non-slip covering sheet according to the invention discussed in previous parts of the specification is applied. This method can be applied e.g. in inter-city buses, aeroplanes or transit-halls of airports.

As it was seen it is advantageous to cover the surface overlaid with table-cloth of a dining table with the covering sheet according to the invention, for example as with a table placemat. Our related method is essentially a method for covering the surface overlaid with table-cloth of a table in which the surface overlaid with table-cloth is covered with a non-slip covering sheet in a way that the lower surface, provided with antislip protrusions, of the non-slip covering sheet is connected with the surface overlaid with table-cloth, the method being new in that as non-slip covering sheet the non-slip covering sheet according to the invention described in previous parts of the specification is applied. This method can be applied e.g. in restaurants.

### DISCLOSURE OF THE DRAWINGS

FIG. 1. shows a household non-slip covering sheet 1 made up in a reel 2. One can observe the reel 2, the winding core 16, the upper surface 3 and the lower surface 4 having antislip protrusions 5.

FIG. 2. is a magnified section of portion “A” of FIG. 1. One can observe the antislip protrusions 5, e.g. hooking protrusions 6, and the granules forming them, e.g. hooking granules 7, which are fixed on the basic granule with the angle of fixation 8, the value of the angle of fixation being e.g. 45°.

FIG. 3. shows the edge 10 of a non-slip covering sheet 1 spread over carpet 9 where there is a sanitary loop 11 formed along the edge 10.

FIG. 4. shows a reel 2 comprising carpet 9 and non-slip covering sheet 1 wound up together with carpet 9 and being contiguous with carpet 9.

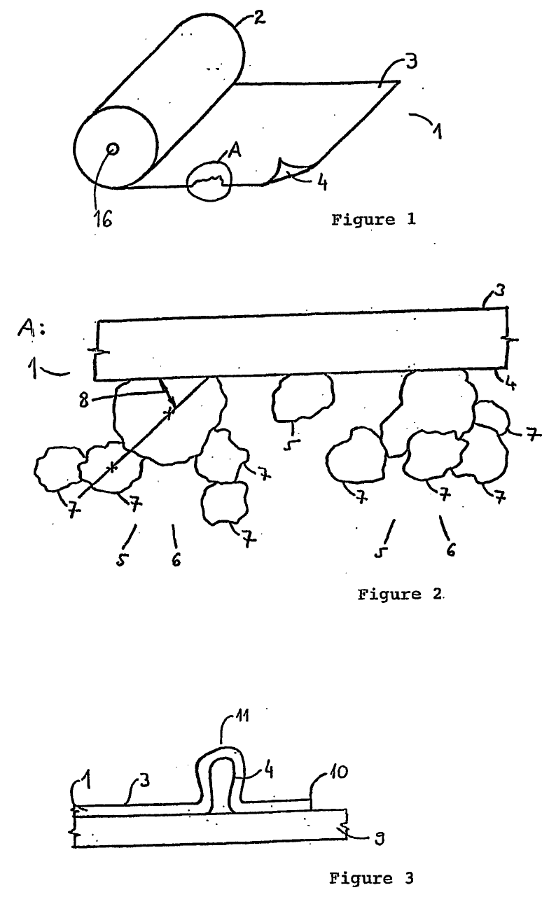

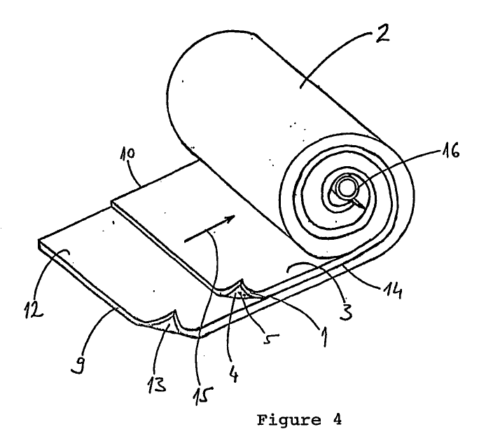

### EXAMPLES

### Example 1.

This example relates to a household non-slip covering sheet 1, in particular for covering the carpeted floor of a fairground, which is a water impermeable high density polyethylene film of 40 microns the density of which is 0.953 kg/m³ and its lower surface 4 is in its full extent roughened with antislip protrusions 5 serving for creating an antislip engagement with the free fibres of the floor carpet. Its antislip protrusions 5 are constituted by rigid and strong roughening particles sprinkled and fixed with a random orientation, with welding, to its lower surface 4, the particles being reactor powder grains of high density polyethylene. The height of the antislip protrusions 5 is between 40 microns and 3000 microns and, within-that, that of their majority is between 200 microns and 700 microns and they are of an average height of 300 microns. The projection of the antislip protrusions 5 to the lower surface 4 is greater than their section with the lower surface 4. The non-slip covering sheet 1 is made up in the form of a reel 2 wound up, in one layer i.e. without a preliminary centre folding or gussetting, around a paper winding core 16 of an inner diameter of 50 mm's and it size is 1×10 metres. The outer surface of the reel 2 is the roughened lower surface 4. The surface closeness of the antislip protrusions 5 is about 40 pieces/cm², their distribution and shape is irregular and of a random character. The antislip protrusions 5 are not equal in height, the quotient between the height of the highest and that of the lowest antislip protrusion 5 is about 3.5. In addition, lower surface 4 comprises, in a lower quantity, softer EVA powder grains which are fixed to it with adhesion. Their height is in an average about 350 microns. The 96% of the antislip protrusions 5 is such that the quotient between the area of the section between the antislip protrusion 5 and the plane of the lower surface 4 on the one hand and the area of the perpendicular projection of the antislip protrusion 5 taken to the plane of the lower surface 4 on the other hand is about 0.5. The body density of the antislip protrusions 5 is about 0.954 kg/m³. The antislip protrusions 5, which are constituted by rough-surfaced grains of reactor powder i.e. grains not ground but made directly chemically, are of a concave surface, in particular of a concave outline.

### Example 2

This example shows a non-slip covering sheet 1, produced very inexpensively thus disposable, absorbent and having an upper surface 3 of a decreased slip, for the covering of the floor carpet in the front foot area of a car. Its water impermeable layer constituting its lower surface 4 is a continuous layer of polyethylene that in its full lower surface 4 carries the antislip protrusions 5 for the antislip engagement with the free fibres of the carpet surface, the antislip protrusions 5 being comprised of rigid and strong polyethylene granules sprinkled and welded with a random orientation to the plastic layer and its other layer is an unsized paper layer constituting the absorbent upper surface 3 of decreased slip onto which the polyethylene layer is fixed in its full surface the kind of fixation being coating with hot, molten polymer. The polyethylene has a chemical composition corresponding to that commonly used with polyethylenes used for coating paper. The mass of the paper is 60 g/m², the mass of the polyethylene layer is 20 g/m², thus the common mass of the lower layers, fixed to each other in the 100% of their surface, of the non-slip covering sheet 1 is 80 g/m², and their united thickness is less than 100 microns. The quantity of the granules constituting the antislip protrusions 5 is 15 g/m². The size, height of the antislip protrusions 5 is between 335 microns and 700 microns and their projection taken to the lower surface 4 is greater than their section with the lower surface 4. Their surface closeness is about 30 to 60 pieces/cm². The width of the non-slip covering sheet 1 is 55 cm, its length is 70 cm and it has, at one of its corners, an arched cut-out having a shape corresponding to the shape of the wheel-drum. It is made up multiply folded.

### Examples 3

This example illustrates a non-slip covering sheet 1, produced very inexpensively thus disposable, absorbent and having an upper surface 3 of a decreased slip, for the covering of the fabric-upholstered luggage compartment of a car. This non-slip covering sheet 1 differs from the one presented in Example 2. in the following. Its shape is a rectangle, its size is 50×100 cm. It is made up in a single wound (i.e. single layer) reel 2 of a width of 50 cm and of a roughened outer surface which can thus be advantageously used in a way that the reel 2 is unrolled in the lengthwise direction of the car onto the floor of the luggage compartment and its edges 10 are adhered onto the slanting carpeted or fabric-upholstered surfaces all around. The majority of the antislip protrusions 5 in the lower surface 4 of the non-slip covering sheet 1 is such a hooking protrusion 6 that comprises such hooking granules 7 that are welded to a granule projecting from the surface typically in a slanting position of e.g. 45°. The hooking granules 7 are smaller than the granules carrying them.

### Example 4

This example shows a non-slip covering sheet 1, of a size of 1×2.5 metres, for protecting the carpet 9 of an entrance hall. Its layer making up its lower surface 4 is a 15 micron polyethylene film which is, in its full surface, roughened by rigid and strong polyethylene granules, of a quantity of 5 g/m², of a size not greater than 500 microns and typically about 250 to 300 microns, welded with a random orientation to the surface and which is thereby provided with antislip protrusions 5 for an antislip engagement with the free fibres of the upholstered or fabric surface. Thus the height of the antislip protrusions 5 is surely between 150 microns and 500 microns and their projection to the lower surface 4 is greater tan their section with the lower surface 4. Its next layer is a crepe paper of a mass of 33 g/m², and this is closed from the top by the hydrophilic non-woven fabric, i.e. fleece, of polypropylene of a mass of 15 g/m², constituting the upper surface 3. The non-woven is a so-called spunbonded non-woven i.e. its fibres are of an infinite length and are fixed to each other with welding at the crossings. The fixation between the said three layers is, in pairs, provided by adhering. The adhesive is a non-water-soluble, crosslinked adhesive that is applied in regularly arranged circular spots making up 5% of the surface. The diameter of the circular spots is 6 mm, and these are, in the two adhesive layers, at identical locations and thus the paper is, from the two sides, fully crossed and soaked by the adhesive this way creating load transmitting bridges that are solid even when wet and that lead through the paper which gets pulped when wet The tearing strength, against a rubbing load arriving from the top, of the lowest water impermeable layer is greater than that of the layers above it. The said polypropylene non-woven overlying the upper surface 3 of the non-slip covering sheet 1 in its full area is such a material of a loose, fibrous structure that has free fibres having free sections fixed at both of their ends to the upper surface 3 whose thickness (about 6 to 10 microns) is much lower than one-fourth of the height of the antislip protrusions 5 and the non-woven is thick and loose to such an extent that makes it possible for the antislip protrusions 5 to enter the fibrous structure by means of the antislip protrusions 5 finding enough room (in the free space among the free fibres of the nonwoven. The tearing strength of the said adhesion fixing the two kinds of plastic layers and the paper layer between each other is lower than the tearing strength of the individual layers. This results in the film, paper and non-woven layers being able to be torn off each other and collected separately for recycling.

### Example 5

The non-slip covering sheet 1 of the example 5 differs from that of Example 4. that between the paper and the polyethylene film there is SuperAbsorbent Polymer (S.A.P.) powder of a quantity of 5 g/m² by which the non-slip covering sheet 1 can absorb up to more than 1 litre/m² of water. Spacers constituted by polystyrene foam beads of a diameter of about 3 mm, located in the same layer, provide free space for the S.A.P. powder. At the edges of the non-slip covering sheet 1 the non-woven and the film are adhered to each other thus preventing the S.A.P. powder from getting out of the product.

### Example 6

The example relates to a non-slip covering sheet 1, for protecting the cleanness of household furniture overlaid with fabric upholstery, bed sheet or fabric, of a size of 1×1.3 m having roughening granules of 80 to 100 microns that, apart from its size and the size of its roughening granules, is identical with the covering sheet of Example 4. Its layer constituting its lower surface 4 is a 15 micron polyethylene film. Its next layer is crepe paper of a mass of 33 g/m² and this is from the top closed by a hydrophilic polypropylene non-woven (i.e. fleece) of a mass of 15 g/m² constituting the upper surface 3. This composition makes the product suitable to be used as a disposable bed covering facing. With its roughened surface it grips well with the fabric upholstery of the bed or the bed sheet but it can still be easily and smoothly spread over the fabric upholstered surface due to its relatively small surface. The product is water impermeable at the bottom, water permeable at the top and has an absorbent layer in the middle hence is can well be utilised for absorbing the body fluids of the bed-ridden person and for keeping the bed clean. Its utilisation is especially advantageous for sick or incontinent persons or for small children during the training for clean habits. Accordingly, it can be utilised, for example, under the bed sheet, as a cross-sheet or lengthwise under the sleeping child or during the changing-of diapers of an infant without a bed sheet laid over the fabric-upholstered furniture or bed under the infant.

### Example 7

A non-slip covering sheet 1 for protecting the cleanness of fabric-upholstered furniture or car seat that, apart from its size, is identical with the covering sheet of Example 6. Its size is 1.5×2.0 m by means of which it is suitable for covering and keeping the cleanness of a coach, armchair or car rear seat used by dogs and cats.

### Example 8

A non-slip covering sheet 1 for protecting the cleanness of fabric-upholstered car seats that, apart from its size, is identical with the covering sheet of Example 7. Its size is 0.7×2.0 m by means of which it is suitable for covering and keeping the cleanness of a front seat of a car during repairing works.

### Example 9

A non-slip covering sheet 1 formed as a disposable table placemat for protecting the cleanness of the table-cloth that, apart from its size, is identical with the covering sheet of Example 8. Its size is 0.5×0.7 m by means of which it is suitable for covering and keeping the cleanness of the table-cloth under one place-setting. It absorbs dripping grease or water and it does not let it get to the table-cloth.

### Example 10

This example relates to a non-slip covering sheet 1 to be used in vehicles, that is manufactured very inexpensively thus is disposable, for the covering of fabric-upholstered headliner panels in the passenger. (and/or luggage or cargo) compartment. Its water impermeable layer, constituting its lower surface 4 (which, at the utilisation, physically gets to the top) is a continuous layer of polyethylene that in its full lower surface 4 carries the antislip protrusions 5 for the engagement, having antislip and lifting strengths, with the fine free fibres of the, common at cars, fleece-upholstery of the headliner, the antislip protrusions 5 being comprised of rigid and strong polyethylene granules sprayed over and welded, with a random orientation, to the plastic layer. Its other layer is a layer of crepe paper, providing a certain cushioning and a certain stretch for the product, constituting the absorbent upper surface 3, onto which crepe paper the polyethylene layer is fixed in its full surface. The kind of the fixing is coating with molten, hot polymer. The mass of the paper is 33 g/m², the mass of the polyethylene is 14 g/m². The quantity of the granules forming the antislip protrusions 5 is 10 g/m². The size, height of the antislip protrusions 5 is 80 to 200 microns and their projection to lower surface 4 is greater than their section with lower surface 4. Their surface closeness is about 30 to 60 pieces/cm². The width and length and also the arched contours of the non-slip covering sheet 1 can be made to exactly fit the inner headliner panel of the given car type. The covering sheet can be spread and smoothed over the inner ceiling immediately after the mounting of the headliner, at the assembly of the car. It is also possible that the headliner is in advance provided with the covering sheet and is mounted into the car together with that. Its main purpose is to protect the car from potential contamination caused by the assembly workers and forwarders during the assembly and before the handing over to the customer. On the other hand, the car can also be used with the covering sheet installed and thus protecting for a long time the cleanness and original colour of the inner headliner upholstery. At this product it is very significant that the new covering sheet, in a unique way, adapts and fixes in its full surface well to the convex-concave, fabric-upholstered surface, essentially facing horizontally downwards, of the covered area and thus a fill, tub-like covering can be formed of it. Its lifting and peeling strength is low enough to permit the correction of a false positioning by lifting off and repositioning and is high enough to prevent the covering sheet from unintentionally falling from the upholstery facing downwards. Its surface facing the passenger compartment is provided with a printed, colourful picture.

### Example 11

This example relates to a system containing the non-slip covering sheet 1 according to the invention. In the system, the fabric-upholstered inner surface of the inner headliner of a car is applied as the covered surface overlaid with fabric. The inner headliner is cut to size, pre-formed and ready to be mounted into the car. The inner headliner is multi-layered. Its lower surface (actually to get, at the mounting, to the top) is prepared to be fixed to the ceiling of the car and its opposite, upper surface (actually to get, at the mounting, to the bottom) is overlaid with the felt-like upholstery comprised of the synthetic non-woven fabric of loose fibrous structure and thin fibres, well known and commonly used for the purpose. The system comprises, as non-slip protecting covering sheet covering the covered surface, the non-slip covering sheet 1 according to Example 10. In the system, the non-slip covering sheet 1 conforms and fixes in its full area well to the fabric-upholstered, somewhat concave surface of the headliner, acting as he covered surface, and thus it forms a complete, tub-like covering. The antislip protrusions 5 of the non-slip covering sheet 1 form an engagement, providing antislip strength as well as lifting strength, with the free fibres of the non-woven fabric overlying the covered headliner. With the mounting of the headliner, the inner upper upholstery of the car is immediately provided with a safe sanitary protection, e.g. against cigarette smoke.

### Example 12

A system comprising the non-slip covering sheet 1 of the invention in the form of a reel 2. The system comprises a carpet 9 of a size of 1×20 m, commonly used for the preparation of the floors of fairgrounds and having, on the one side, a walking surface 12 overlaid with fabric and, on the other side, an adhesion surface 13. The whole walking surface 12 of the carpet 9 is covered with a non-slip covering sheet 1 whose size is also 1×20 m and whose quality is identical with that of the non-slip covering sheet 1 of Example 1. The lower surface 4 of the non-slip covering sheet 1 is in connection with the walking surface 12, it is smoothed onto it, it is contiguous with it in its full surface and its antislip protrusions 5 are in an antislip engagement with the free fibres of the fabric overlying the walking surface 12. Thus the non-slip covering sheet 1 and the carpet 9 constitute a unitarily handle-able multilayer material 14 which forms a reel 2, which reel 2 is made up around a paper winding core 16 of an inner diameter of 76 mm and comprises multilayer material 14 of a width of 1 m and of a length, measured in the reeling forwarding direction 15, of 20 m. The lower surface 4 of the non-slip covering sheet 1, comprising the antislip protrusions 5, is the surface looking outwards of the reel 2 of the non-slip covering sheet 1 and the adhesion surface 13 of the carpet 9 faces outwards, towards the outer side of the reel 2. Hence the carpet 9, covered with the non-slip covering sheet 1, can be spread in one step with the unrolling of the reel 2. According to other possible embodiments, the said width can also be 2.5 m or 4 m rather than 1 m.

### Example 13-20

Example 13. presents a process for the utilisation. In the process, the covering sheet of Example 2. is applied as a non-slip covering sheet 1. In a car, the fabric-upholstered surface of the front foot area is covered with the non-slip covering sheet 1 in a way that its lower surface 4, having the antislip protrusions 5, is connected with the fabric-upholstered surface.

Example 14. presents a process for the utilisation. In the process, the covering sheet of Example 10. is applied as a non-slip covering sheet 1. The fabric-upholstered surface of the headliner unit, to be mounted into the car later, is covered with the non-slip covering sheet 1 in a way that its lower surface 4, comprising the antislip protrusions 5, is brought into touch with the fabric-upholstered surface. It is made sure that the size and shape of the non-slip covering sheet 1 fit the headliner unit.

Example 15. presents a process for the utilisation. In the process, the covering sheet of Example 1. is applied as a non-slip covering sheet 1. The floor, overlaid with carpet 9, of the fairground is covered, for sanitary purposes, with the non-sip covering sheet 1 in a way that its lower surface 4, carrying the antislip protrusions 5, is made to contact the carpet 9. The free side edges 10 of the non-slip covering sheet 1 are adhered down with tapes.

Example 16. presents a process for the utilisation. In the process, the reel 2 constituted by the system presented in Example 12. is applied as a reel 2 containing carpet 9. The fairground floor to be covered with carpet 9 is covered with carpet 9 in a way that the reel 2 is placed on the floor and is unrolled, with the adhesion surface 13 of the carpet 9 facing downwards and with the non-slip covering sheet 1 facing upwards. With the unrolling the carpet 9 being in the reel 2 and the non-slip covering sheet 1, covering its walking surface 12 and thus now getting on the top, are simultaneously spread. The adhesion surface 13 of the carpet 9 is adhered to the floor. The carpet 9 and the non-slip covering sheet 1 are, at the necessary places, around the edges 10 and at the joints, are simultaneously cut into the suitable shape and size. Finally, the free side edges 10 of the non-slip covering sheet I are adhered down wit a tape.

Example 17. presents a process for the manufacturing of a carpet reel provided with covering sheet. In the process, the carpet 9 of Example 12. is applied as carpet 9 and the non-slip covering sheet 1 of Example 12. is applied as non-slip covering sheet 1. The carpet 9 is pulled with a given line speed, slid over a horizontal table, with its walking surface 12 facing upwards. Simultaneously, the non-slip covering sheet 1, which is being pulled with an identical line speed, is laid, looped around a roll rolling upon the carpet 9 sliding on the table, onto the walking surface 12 of the carpet 9 with its lower surface 4 comprising the antislip protrusions 5 facing toward the carpet 9. Then the multilayer material 14 constituted by the carpet 9 and the non-slip covering sheet 1, lying on each other, is pulled further and this way their uniform length is assured. Finally the multilayer material 14 is rewound around a winding core 16 during which it is assured that the adhesion surface 13 of the carpet 9 looks towards the outer side of the reel 2 and the upper surface 3 of the non-slip covering sheet 1 looks toward the winding core 16. In the meantime the non-slip covering sheet 1 is, to a certain extent, wrinkled, compressed within the reel 2 by which the smooth final spreadability of the multilayer material 14 is ensured.

Example 18. presents a process for the utilisation. In the process, the disposable patient-underpad of Example 6. is applied as a non-slip covering sheet 1. The surface of the mattress of the hospital bed, overlaid with bed sheet, is covered with the disposable patient-underpad in a way that its lower surface 4, carrying the antislip protrusions 5, is made to contact the bed sheet.

Example 19. presents a process for the utilisation. In the process, the disposable nonslip covering sheet 1 of Example 7. is applied as a non-slip covering sheet 1. The fabric-upholstered surface of the armchair used by a pet, e.g. a dog, is covered with the non-slip covering sheet I in a way that its lower surface 4, carrying the antislip protrusions 5, is made to contact the fabric upholstery.

Example 20. presents a process for the utilisation. In the process, the disposable table placemat of Example 9. is applied as a non-slip covering sheet 1. The surface of the restaurant table overlaid with table-cloth is covered with the disposable table placemat in a way that its lower surface 4, carrying the antislip protrusions 5, is made to contact the table-cloth.

1. Non-slip covering sheet (1) for covering surfaces overlaid with fabric that on its lower surface (4) to be connected with the fabric overlying the surface to be covered, on the entire surface or on its one or more parts, has antislip protrusions (5) for the antislip engagement with the free fibres of the fabric overlying the surface to be covered, characterised in that its antislip protrusions (5) are constituted by suitably rigid and strong roughening particles fixed with a random orientation to its lower surface (4) and at least some of the antislip protrusions (5) are such that their height is between 40 microns and 3000 microns and their perpendicular projection to the lower surface (4) is bigger than their section with the lower surface (4) and the non-slip covering sheet (1) is wound up in a reel (2) around a winding core (16) and/or has a size smaller than or equal to 20 square metres.

2. Non-slip covering sheet (1) according to claim 1., characterised in that its roughening particles constituting its antislip protrusions (5) are granules.

3. Non-slip covering sheet (1) according to any of claims 1 to 2., characterised in that the greatest size of at least a part of its antislip protrusions (5) is between 150 microns and 1000 microns.

4. Non-slip covering sheet (1) according to any of claims 1 to 3., characterised in that the greatest size of at least a part of its antislip protrusions (5) is between 200 microns and 700 microns.

5. Non-slip covering sheet (1) according to any of claims 1 to 4., characterised in that the quotient of the heights of its highest and lowest antislip protrusions (5) is at least 1.1.

6. Non-slip covering sheet (1) according to any of claims 1 to 5., characterised in that the quotient of the heights of its highest and lowest antislip protrusions (5) is at least 1.5.

7. Non-slip covering sheet (1) according to any of claims 1 to 6., characterised in that at least a part of the antislip protrusions (5) of its lower surface (4) is such that the quotient of the area of the section of the antislip protrusion (5) with the plane of the lower surface (4) and the area of the perpendicular projection of the antislip protrusion (5) to the plane of the lower surface (4) is at least 0.05.

8. Non-slip covering sheet (1) according to any of claims 1 to 7., characterised in that at least a part of the antislip protrusions (5) of its lower surface (4) is such that the quotient of the area of the section of the antislip protrusion (5) with the plane of the lower surface (4) and the area of the perpendicular projection of the antislip protrusion (5) to the plane of the lower surface (4) is at most 0.95.

9. Non-slip covering sheet (1) according to any of claims 1 to 8., characterised in that the body density of at least a part of its antislip protrusions (5) is greater than 500 kg/m³.

10. Non-slip covering sheet (1) according to any of claims 1 to 9., characterised in that its lower surface (4) is a water-impermeable plastic layer, e.g. polyethylene.

11. Non-slip covering sheet (1) according to any of claims 1 to 10., characterised in that the common mass of its lower layers fixed to each other in pairs in surface parts being essentially uniformly distributed and making up at least 5% of their surface is at least 10 grams per square metre.

12. Non-slip covering sheet (1) according to any of claims 1 to 11., characterised in that the surface of at least a part of its antislip protrusions (5) is concave.

13. Non-slip covering sheet (1) according to any of claims 1 to 12., characterised in hat at least a part of its antislip protrusions (5) are of concave outlines.

14. Non-slip covering sheet (1) according to any of claims 1 to 13., characterised in that it has in its lower surface (4) such hooking protrusions (6) that contain such a hooking particle, preferably hooking granule (7), that is, directly or indirectly, fixed to some protrusion projecting from the lower surface (4).

15. Non-slip covering sheet (1) according to claim 14., characterised in that it has in its lower surface (4) such hooking protrusions (6) that contain such a hooking particle, preferably hooking granule (7), that is, directly or indirectly, fixed slanted to a granule fixed to the lower surface (4).

16. Non-slip covering sheet (1) according to any of claims 1 to 15., characterised in that its size is smaller than or equal to 5 m² and/or it is free of gussets made from the roughened side.

17. Non-slip covering sheet (1) according to any of claims 1 to 16., characterised in that its upper surface (3) has on its entire surface or on part or parts of its surface, as antislip means, roughening, foamed layer and/or elastic layer and/or rubber-like layer and/or a material of a filamentous and/or fibrous structure.

18. Non-slip covering sheet (1) according to any of claims 1 to 17., characterised in that it has an absorbent means at least partially absorbing the moisture getting to its upper surface (3).

19. Non-slip covering sheet (1) according to any of claims 1 to 18., characterised in that its water impermeable layer constituting its lower surface (4) is a continuous plastic layer carrying the antislip protrusions (5) that are plastic granules fixed to the plastic layer, and its other layer is a paper layer constituting the absorbent upper surface (3) of a reduced slip to which the plastic layer is fixed in its whole surface.

20. Non-slip covering sheet (1) according to any of claims 1 to 19., characterised in that its upper surface (3), in the whole of its surface or in one or more surface parts, has roughened paper and/or resilient foamed material and /or non-woven fabric as a surface covering.

21. Non-slip covering sheet (1) according to any of claims 1 to 20., characterised in that its upper surface (3), in the whole of its surface or in one or more surface parts, has, as a surface covering, a material of a loose fibrous structure that has free fibres and/or bundles of fibres that have free sections fixed at both ends to the upper surface (3), in which the thickness of at least a part of the free fibres and/or bundles of fibres is smaller than the half of the height of at least a part of the antislip protrusions (5) and in which the material of fibrous structure is thick to such an extent and the looseness of its fibrous structure is of such an extent which makes it possible for at least a part of the antislip protrusions (5) to enter the fibrous structure by means of at least a part of the antislip protrusions (5) finding room in the free space between the free fibres and/or bundles of fibres of the material of fibrous structure.

22. Non-slip covering sheet (1) according to any of claims 1 to 21., characterised in that its components dissimilar in the respect of recyclability are formed in separate layers of inherent strength which layers have such fixing between each other whose tearing strength is lower than the tearing strength of the individual layers.

23. Non-slip covering sheet (1) according to any of claims 1 to 22., characterised in that it is formed as a non-slip covering sheet (1) for the protecting covering of fabric-upholstered household floors, e.g. carpets (9).

24. Non-slip covering sheet (1) according to any of claims 1 to 22., characterised in that it is formed as a bed covering facing or patient-underpad comprising antislip protrusions (5) for the antislip engagement with the fibres of the fabric or bed sheet overlying the lying surface to be covered.

25. Non-slip covering sheet (1) according to any of claims 1 to 22., characterised in that it is formed as a furniture- or seat cover comprising antislip protrusions (5) for the antislip engagement with the fibres of the fabric upholstery of the sitting or lying surface to be covered.

26. Non-slip covering sheet (1) according to any of claims 1 to 22., characterised in that it is formed as a table covering sheet or table placemat comprising antislip protrusions (5) for the antislip engagement with the fibres of the table-cloth overlying the table to be covered.

27. Non-slip covering sheet (1) according to any of claims 1 to 22., characterised in that it is formed as a non-slip covering sheet (1) for covering the fabric-upholstered surfaces of the passenger and/or luggage or cargo compartment of a vehicle.

28. Non-slip covering sheet (1) according to claim 27., characterised in that it is formed as a covering sheet for covering the downward-facing, slanting or essentially horizontal, fabric-upholstered surfaces of the passenger and/or luggage or cargo compartment having antislip protrusions (5) for creating with the free fibres of the upholstery an engagement of appropriate lifting and peeling strength.

29. Non-slip covering sheet (1) according to any of claims 27 to 28., characterised in that it is formed as a covering sheet for covering the fabric-upholstered inner headliner of the passenger and/or luggage or cargo compartment

30. Non-slip covering sheet (1) according to any of claims 27 to 29., characterised in that it is formed, by means of its suitable shape and its antislip protrusions (5) serving for an engagement of suitable lifting and peeling strength with the free fibres of the fabric-upholstery to be covered, as a covering sheet for covering the inner headliner fabric upholstery of the passenger and/or luggage or cargo compartment.

31. Non-slip covering sheet (1) according to any of claims 27 to 30., characterised in that it has decorative pictures, image or text in its upper surface (3) opposite to its antislip protrusions (5).

32. System that comprises a covered surface overlaid with fabric and a non-slip protecting covering sheet covering the covered surface which non-slip protecting covering sheet has in its lower surface (4) facing the covered surface antislip protrusions (5) forming an antislip engagement with the free fibres of the fabric overlying the covered surface, characterised in that as non-slip protecting covering sheet it comprises the nonslip covering sheet (1) according to any of claims 1 to 31.

33. System according to claim 32., characterised in that it comprises a carpet (9), having a walking surface (12) overlaid with fabric on its one side and an adhesion surface (13) on its other side, and as a covered surface overlaid with fabric it comprises the walking surface (12) overlaid with fabric of the carpet (9) and it comprises, at least partly, the multilayer material (14) composed of the carpet (9) and the non-slip covering sheet (1) covering its walking surface (12) and being contiguous and in a non-slip engagement with its walking surface (12) in the form of a reel.

34. System according to claim 33., characterised in that the length, measured in the reeling forwarding direction (15), of the non-slip covering sheet (1) and that of the carpet (9) are, within the turns of the reel (2), within the multilayer material (14), essentially the same.

35. System according to any of claims 33 to 34., characterised in that the lower surface (4) of the non-slip covering sheet (1) having the antislip protrusions (5) is that surface of the non-slip covering sheet (1) that faces towards the outer side of the reel (2).

36. Method for covering surfaces overlaid with fabric in which the surface overlaid with fabric is covered with a non-slip covering sheet (1) in a way that the lower surface (4), provided with antislip protrusions (5), of the non-slip covering sheet (1) is connected with the surface overlaid with fabric, characterised in that as non-slip covering sheet (1) the non-slip covering sheet (1) according to any of claims 1 to 31. is applied.

37. Method for covering surfaces overlaid with fabric of passenger and/or luggage or cargo compartments of vehicles in which the surface overlaid with fabric is covered with a non-slip covering sheet (1) in a way that the lower surface (4), provided with antislip protrusions (5), of the non-slip covering sheet (1) is connected with the surface overlaid with fabric, characterised in that as non-slip covering sheet (1) the non-slip covering sheet (1) according to any of claims 1 to 22. and 27 to 31. is applied.

38. Method for covering surfaces overlaid with fabric of parts to be mounted into passenger and/or luggage or cargo compartments of vehicles in which the surface overlaid with fabric is covered with a non-slip covering sheet (1) in a way that the lower surface (4), provided with antislip protrusions (5), of the non-slip covering sheet (1) is connected with the surface overlaid with fabric, characterised in that as non-slip covering sheet (1) the non-slip covering sheet (1) according to any of claims 1 to 22. and 27 to 31. is applied.

39. Method for covering household floors overlaid with fabric, e.g. carpets (9), for protection in which the surface overlaid with fabric is covered with a non-slip covering sheet (1) in a way that the lower surface (4), provided with antislip protrusions (5), of the non-slip covering sheet (1) is connected with the surface overlaid with fabric, characterised in that as non-slip covering sheet (1) the non-slip covering sheet (1) according to any of claims 1 to 23. is applied.

40. Method for overlaying floors with carpet (9) in which a reel (2) containing carpet (9) is provided, the material forming the reel (2) is unrolled and the carpet (9) is spread and smoothed over the floor surface with its adhesion surface (13) facing towards the floor and with its walking surface (12) facing upwards, characterised in that as a reel (2) containing carpet (9) the system according to any of claims 33 to 35., comprising a reel (2) formed by a multilayer material (14), is provided.

41. Method for producing a reel of carpet (9) provided with covering sheet in which before the rewinding or during the rewinding the walling surface (12) of the carpet (9) is covered with a non-slip covering sheet (1) and thereby a reel (2), formed of a multilayer material (14) consisting of the carpet (9) and the non-slip covering sheet (1) covering its walking surface (12) and being contiguous and in an antislip engagement with its walking surface (12), is created, characterised in that as a non-slip covering sheet (1) the non-slip covering sheet (1) according to any of claims 1 to 31. is applied.

42. The method according to claim 41., characterised in that the multilayer material (14) is formed of a carpet (9) and a non-slip covering sheet (1) of essentially the same length.

43. The method according to any of claims 41 to 42., characterised in that the non-slip covering sheet (1) is positioned in the reel (2) in a way that its lower surface (4) having antislip protrusions (5) is made to be its surface facing towards the outer side of the reel (2).

44. Method for covering lying surfaces overlaid with fabric or bed sheet in which the lying surface overlaid with fabric or bed sheet is covered with a non-slip covering sheet (1) in a way that the lower surface (4), provided with antislip protrusions (5), of the non-slip covering sheet (1) is connected with the surface overlaid with fabric or bed sheet, characterised in that as non-slip covering sheet (1) the non-slip covering sheet (1) according to any of claims 1 to 22. and 24. is applied.

45. Method for covering fabric-upholstered sitting or lying surfaces of pieces of furniture or seats in which the fabric-upholstered sitting or lying surface is covered with a non-slip covering sheet (1) in a way that the lower surface (4), provided with antislip protrusions (5), of the non-slip covering sheet (1) is connected with the fabric-upholstered surface, characterised in that as non-slip covering sheet (1) the non-slip covering sheet (1) according to any of claims 1 to 22. and 25. is applied.

46. Method for covering the surface overlaid with table-cloth of a table in which the surface overlaid with table-cloth is covered with a non-slip covering sheet (1) in a way that the lower surface (4), provided with antislip protrusions (5), of the non-slip covering sheet (1) is connected with the surface overlaid with table-cloth, characterised in that as non-slip covering sheet (1) the non-slip covering sheet (1) according to any of claims 1 to 22. and 26. is applied.
